(19) United States
(12) Patent Application Publication
(10) Pub. No.: US 2010/0161849 A1
(43) Pub. Date: Jun. 24, 2010

(54) MULTI CHANNEL DATA TRANSFER DEVICE

(76) Inventors: Jung-Hee SUK, Daejeon (KR); Ik-Jae CHUN, Daejeon (KR); Yil-Suk YANG, Daejeon (KR); Se-Wan HEO, Daejeon (KR); Tae-Moon ROH, Daejeon (KR); Jong-Dae KIM, Daejeon (KR)

Correspondence Address: LADAS & PARRY LLP, 224 SOUTH MICHIGAN AVENUE, SUITE 1600, CHICAGO, IL, 60604, US

(21) Appl. No.: 12/484,500

(22) Filed: Jun. 15, 2009

(30) Foreign Application Priority Data
Dec. 22, 2008 (KR) 10-2008-0131186

(51) Int. Cl. G06F 13/28

(52) U.S. Cl. 710/23

(57) ABSTRACT

Provided is a multi channel data transfer device. The multi channel data transfer device includes: a plurality of channel control unit connected to a plurality of peripheral devices, respectively; a plurality of control registers storing setting data for controlling an operation of each of the plurality of channel controllers; and a common register controller delivering common setting data to all or part of the plurality of control registers, the common setting data being applied in common to all or part of the plurality of channel controllers.

### CROSS-REFERENCE TO RELATED APPLICATIONS

This U.S. non-provisional patent application claims priority under 35 U.S.C. §119 of Korean Patent Application No. 10-2008-0131186, filed on Dec. 22, 2008, the entire contents of which are hereby incorporated by reference.

### BACKGROUND OF THE INVENTION

The present invention disclosed herein relates to a multi channel data transfer device transmitting data through a plurality of channels.

A multimedia processor processes a large capacity of data. The performance of the multimedia processor depends on a data transfer speed between a processing module and a memory. In order to improve a data transfer speed, a direct memory access (DMA) technique is used.

In relation to the DMA technique, a processor is not responsible for data transfer during the transferring of data. Instead of that, data are directly transferred between a peripheral device and a memory using an additional data transfer device. That is, according to the DMA technique, a DMA controller is charge of transferring data instead of the processor. Data transfer is accomplished at a high speed between a memory and a peripheral device according to a control of the DMA controller.

However, a plurality of peripheral circuits are connected to a recent microprocessor. For example, a solid state drive, a hard disk drive, a DVD-ROM drive, an USB storage, and so forth may be connected to one microprocessor. Accordingly, data transfer efficiency is required between a microprocessor and a plurality of peripheral circuit devices. To resolve this, a multi channel data transfer device having a plurality of transfer channels is used. In the multi channel data transfer device, each peripheral circuit uses a different channel in order to transfer data.

However, while the multi channel data are transferred, control registers in each channel are required to be set in order to control an operation of each channel. Since it takes a relatively long time to set a plurality of control registers, system performance is deteriorated.

### SUMMARY OF THE INVENTION

The present invention provides a multi channel data transfer device capable of reducing a control load caused by a processor and improving efficiency of a system bus by minimizing register setting repetition accompanied by a multi channel transfer.

Embodiments of the present invention provide multi channel data transfer devices including: a plurality of channel controllers connected to a plurality of peripheral devices, respectively; a plurality of control registers storing setting data for controlling an operation of each of the plurality of channel controllers; and a common register control unit delivering common setting data to all or part of the plurality of control registers, the common setting data being applied in common to all or part of the plurality of channel controllers.

In some embodiments, the common register control unit includes: a common register receiving setting data from the external; a common register controller generating the common setting data from the setting data stored in the common register; and a selection circuit delivering the common setting data to all or part of the plurality of control registers according to a control of the common register controller.

In other embodiments, the common register controller includes: a common condition analyzer analyzing information with reference to the setting data and generating a control signal, the information being about a channel and a sub channel to which the common setting data are applied; a channel selector selecting a channel in response to the control signal and the setting data; and an address operator generating an address in response to the control signal and the setting data.

In still other embodiments, the common register includes a register storing information about a channel and a sub channel where the common setting data are to be used. The common register includes a register controlling which data among the setting data are to be used in a plurality of channels. The common register includes a register storing the setting data to be used in a plurality of channels. The common register includes a register controlling which data among the setting data are to be used in a plurality of sub channels. The common register includes a register storing data to be used in a plurality of sub channels.

In even further embodiments, the common register includes: a first register storing information about a channel and a sub channel where the common setting data are to be used; a second register controlling which data among the setting data are to be used in a plurality of channels; a third register storing the setting data to be used in the plurality of channels; a fourth register controlling which data among the setting data are to be used in a plurality of sub channels; and a fifth register storing data to be used in the plurality of sub channels.

In yet further embodiments, the common register controller includes a common condition analyzer analyzing information with reference to the first, second, and fourth registers and generating a control signal, the information being about a channel and a sub channel to which the common setting data are to be applied. The common register controller further includes a channel selector selecting a channel in response to the third and fifth registers and the control signal.

### BRIEF DESCRIPTION OF THE FIGURES

The accompanying figures are included to provide a further understanding of the present invention, and are incorporated in and constitute a part of this specification. The drawings illustrate exemplary embodiments of the present invention and, together with the description, serve to explain principles of the present invention. In the figures:

FIG. 1 is a block diagram illustrating an example of a typical structure of a computer system using a DMA technique;

FIG. 2 is a block diagram illustrating an example of a multi channel data transfer device according to an embodiment;

FIG. 3 is a block diagram illustrating an example of a common register and a common register controller of FIG. 2; and

FIGS. 4 through 8 are views illustrating an example of first to fifth registers of FIG. 3.

### DETAILED DESCRIPTION OF PREFERRED EMBODIMENTS

Embodiments will be described below in more detail with reference to the accompanying drawings. The embodiments may, however, be embodied in different forms and should not be construed as limited to the embodiments set forth herein. Rather, these embodiments are provided so that this disclosure will be thorough and complete, and will fully convey the scope of the embodiments to those skilled in the art.

It should be construed that foregoing general illustrations and following detailed descriptions are exemplified and an additional explanation of claimed inventions is provided. Reference numerals are indicated in detail in preferred embodiments, and their examples are represented in reference drawings. In every possible case, like reference numerals are used for referring to the same or similar elements in the description and drawings.

Below, a multi channel data transfer device is used as one example for illustrating characteristics and functions of the embodiments. However, those skilled in the art can easily understand other advantages and performances of the embodiments according to the descriptions. The embodiments may be embodied or applied through other embodiments. Besides, the detailed description may be amended or modified according to viewpoints and applications, not being out of scopes, technical ideas, and other objects of the embodiments.

A typical processor controls a peripheral device by writing/reading data into/from the peripheral device. The processor utilizes a local bus to control the peripheral device. However, because capacity of sound data or image data is large, it takes a considerable time to store/read data in/from a peripheral device. As a result, a time during which a processor uses a local bus is increased.

The following processes are performed to store data in a peripheral device. First, data to be stored in the peripheral device is read from a memory into a register in a processor. Second, the data stored in the register of the processor are stored in the peripheral device.

However, since the processor controls the above processes, it may not be available to other tasks. This deteriorates a speed of a computer system. To resolve this limitation, a direct memory access (DMA) technique comes out.

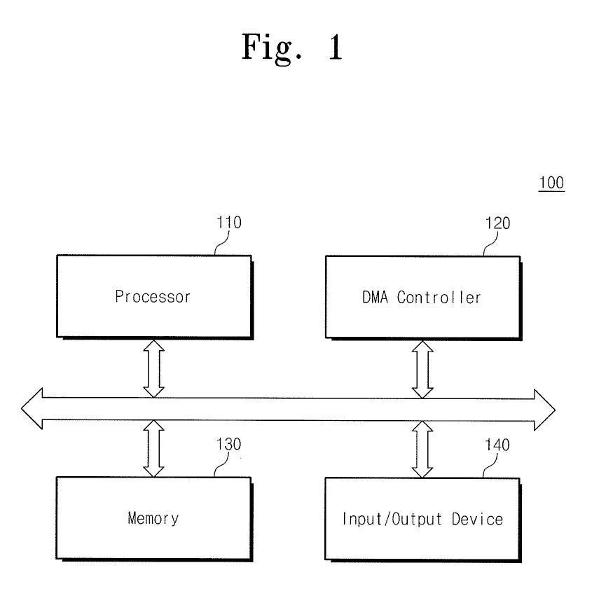

FIG. 1 is a block diagram illustrating an example of a typical structure of a computer system using a DMA technique. Referring to FIG. 1, the computer system 100 includes a processor 110, a DMA controller 120, a memory 130, and an input/output device 140.

The processor 110 delivers an address of data to be transmitted and an address of the input/output device 140, that is, a transfer target, to the DMA controller 120 in order to transfer data from the memory 130 to the input/output device 140. Additionally, the processor 110 delivers the size of the data to be transferred into the DMA controller 120. Moreover, the processor 110 delivers a data transfer command to the DMA controller 120.

Once the data transfer command is delivered from the processor 110, the DMA controller 120 requests a control right of a local bus to the processor 110. After the processor 110 hands over the control right of the local bus to the DMA controller 120, the DMA controller 120 controls data transfer between the memory 130 and the input/output device 140. At this point, since data transfer does not require command interpretation of the DMA controller 120, it is accomplished at a high speed. Once data transfer is completed, the DMA controller 120 returns the control right of the local bus to the processor 110 and delivers interrupt, which notifies that the data transfer is completed, to the processor 110.

However, data transfer efficiency is required for a recent media processor. In order to improve the data transfer efficiency, a multi channel data transfer device having a plurality of transfer channels is used.

A typical multi channel data transfer device includes a plurality of transfer channels. Each transfer channel includes a control register and a channel controller. Each control register controls a channel controller according to received setting data. If this method is used, a considerable time is required to set a plurality of control registers. This consumes an operating time of the processor.

However, when a large capacity of data is transferred from a memory to a plurality of peripheral devices or from a plurality of peripheral devices to a memory, setting data (an address, an address offset, a transfer direction, a data width, a transfer size, a repetition number) for setting each control register are almost the same.

In the embodiment, common setting data among setting data for setting a plurality of control registers are stored in a common register. The common register controller analyzes setting data stored in the common register in order to deliver the setting data to a control register of each channel. Accordingly, the processor does not need to deliver the setting data to each control register. As a result, an operation time consumed for control register setting by the processor is minimized such that it is possible to improve the performance of the multimedia processor.

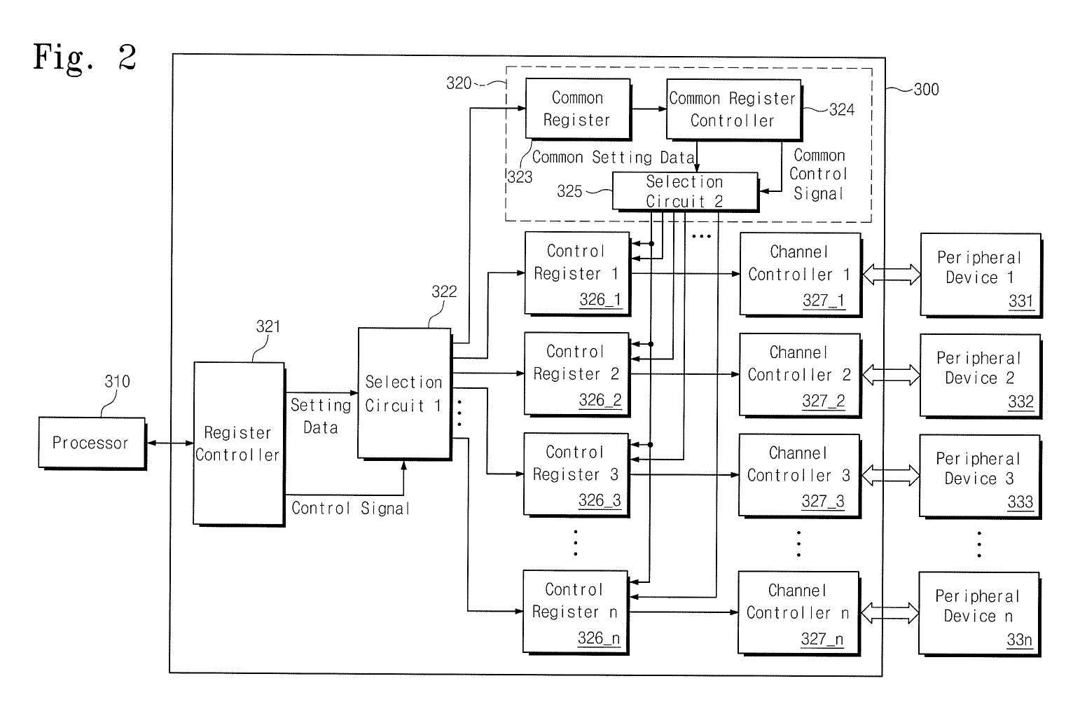

FIG. 2 is a block diagram illustrating an example of a multi channel data transfer device according to an embodiment. Referring to FIG. 2, a multi channel data transfer device 300 includes a register controller 321, a first selection circuit 322, a common register 323, a common register controller 324, a second selection circuit 325, and a plurality of transfer channels.

Each transfer channel includes control registers 326_1 to 326_n and channel controllers 327_1 to 327_n. The common register 323, the common register controller 324, and the second selection circuit 325 constitute a common register control unit 320.

The processor 310 delivers control values for controlling an operation of each channel to the register controller 321 through a bus. The control value may be a source address, a target address, an offset value, a transfer number, a transfer repetition value, a channel activation value, a transfer direction, a data width, an activation sub channel number.

The register controller 321 delivers setting data and a control signal to the first selection circuit 322. The setting data set up an operational condition of each channel. The control signal controls a control register where the setting data are to be stored.

The first selection circuit 322 delivers setting data to one of the control registers 326_1 to 326_n in response to the control signal. The control registers 326_1 to 326_n control corresponding channel controllers 327_1 to 327_n according to the setting data.

Additionally, the first selection circuit 322 delivers the setting data to the common register 323 in response to the control signal. The common register 323 analyzes the setting data and delivers common setting data and a common control signal to the second selection circuit 325. The common setting data are setting data used for setting a plurality of channels. The common control signal controls the control register where the common setting data are to be stored.

The second selection circuit 325 delivers the common setting data to the control registers 326_1 to 326_n in response to the common control signal. The control registers 326_1 to 326_n control the channel controllers 327_1 to 327_n, respectively, according to the common setting data.

As mentioned above, the setting data that are commonly used in each channel are simultaneously delivered to the control registers 326_1 to 326_n according to a control of the common register controller 324. Accordingly, performance deterioration caused by delivering the setting data sequentially to each channel through the processor 310 can be prevented.

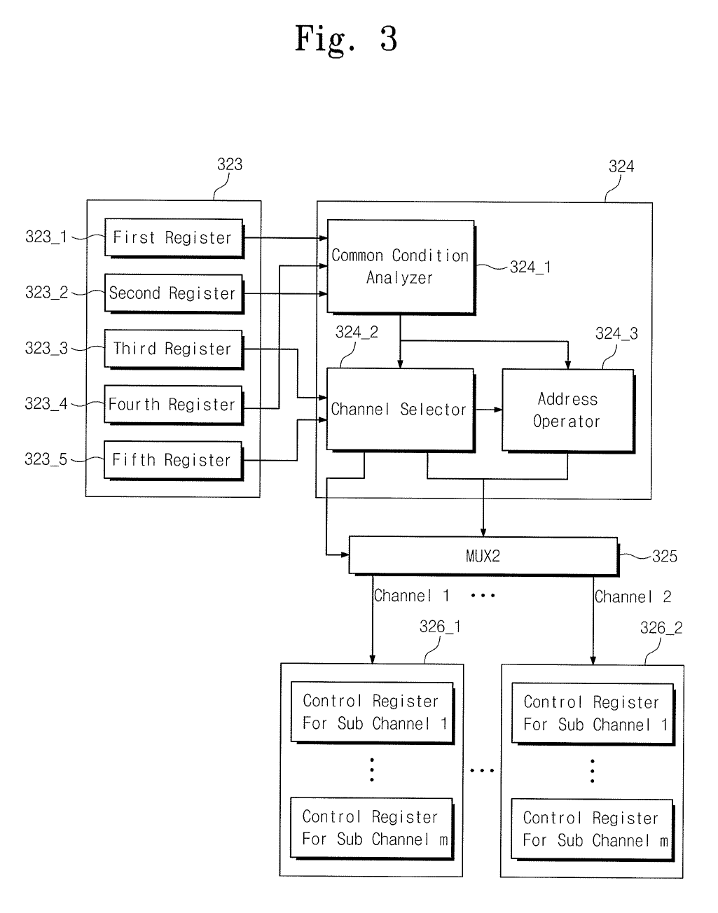

FIG. 3 is a block diagram illustrating an example of the common register and the common register controller of FIG. 2. Referring to FIG. 3, the common register 323 includes first to fifth registers 323_1 to 323_5.

The first register 323_1 stores information about a channel and a sub channel used for common setting data. The second register 323_2 controls which data among the setting data are used for a plurality of channels. The third register 323_3 stores setting data to be used in a plurality of channels. The fourth register 323_4 controls which data among the setting data are used for a plurality of sub channels. The fifth register 323_5 stores data to be used in the plurality of sub channels. The first to fifth registers 323_1 to 323_5 will be described with reference to the drawings.

The common register controller 324 includes a common condition analyzer 324_1, a channel selector 324_2, and an address operator 324_3. The common condition analyzer 324_1 generates a control signal with reference to the first register 323_1, the second register 323_2, and the fourth register 323_4. The control signal controls a channel where common setting data are to be used. The generated control signal is delivered to the channel selector 324_2 and the address operator 324_3.

The channel selector 324_2 generates a common control signal in response to the control signal. The common control signal is delivered to the second selection circuit 325. Additionally, the channel selector 324_2 generates common setting data with reference to the third register 323_3 and the fifth register 323_5. The common setting data are delivered to the address operator 324_3 and the second selection circuit 325.

The address operator 324_3 generates an address with reference to the control signal from the common condition analyzer 324_1 and the common setting data from the channel selector 324_2. Because address offsets of peripheral devices are the same typically, the address operator 324_3 can generate an address with reference to an initial address delivered from the channel selector 324_2. As a result, repetitive address data are reduced such that system performance can be improved.

The common setting data and the common control signal outputted from the common register controller 324 are delivered to the second selection circuit 325. The second selection circuit 325 delivers the common setting data to the plurality of control registers 326_1 to 326_n with reference to the common control signal. Each of the control registers 326_1 to 326_n sets up a corresponding channel controller with reference to the common setting data.

Additionally, each of the control registers 326_1 to 326_n includes a plurality of control registers for a sub channel. One channel may be divided into a plurality of sub channels. At this point, since each sub channel is independently used, respectively different setting data are required. Accordingly, the plurality of control registers for a sub channel are provided to store setting data for each sub channel.

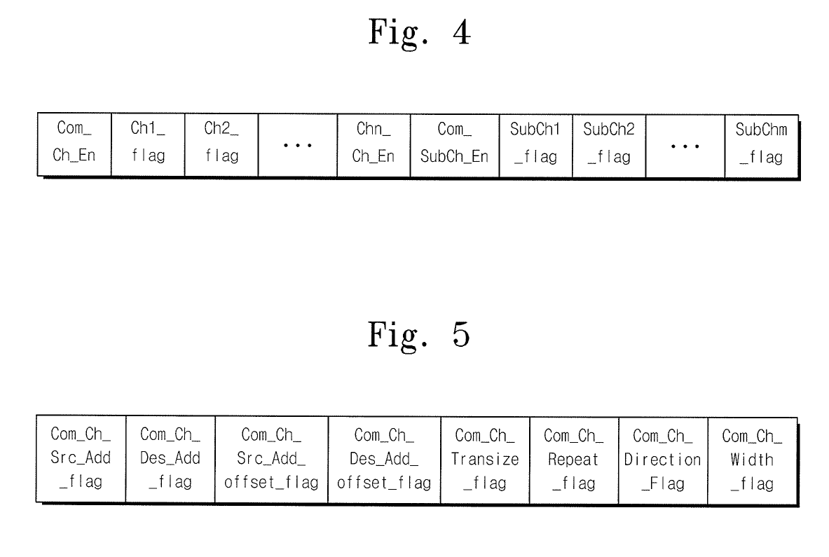

FIGS. 4 through 8 are views illustrating an example of the first to fifth registers of FIG. 3.

FIG. 4 illustrates the detailed first register of FIG. 3. The first register stores information about a channel and a sub channel where common setting data are to be used. For example, once an item Ch1_flag is activated, the common setting data are transferred to the first channel and the first channel controls a channel using the common setting data.

FIG. 5 illustrates the detailed second register of FIG. 3. The second register controls which data among the setting data are to be used in a plurality of channels. For example, once an item Com_Ch_Src_Add_flag is activated, a source address indicating a data stored location is transferred to a plurality of channels.

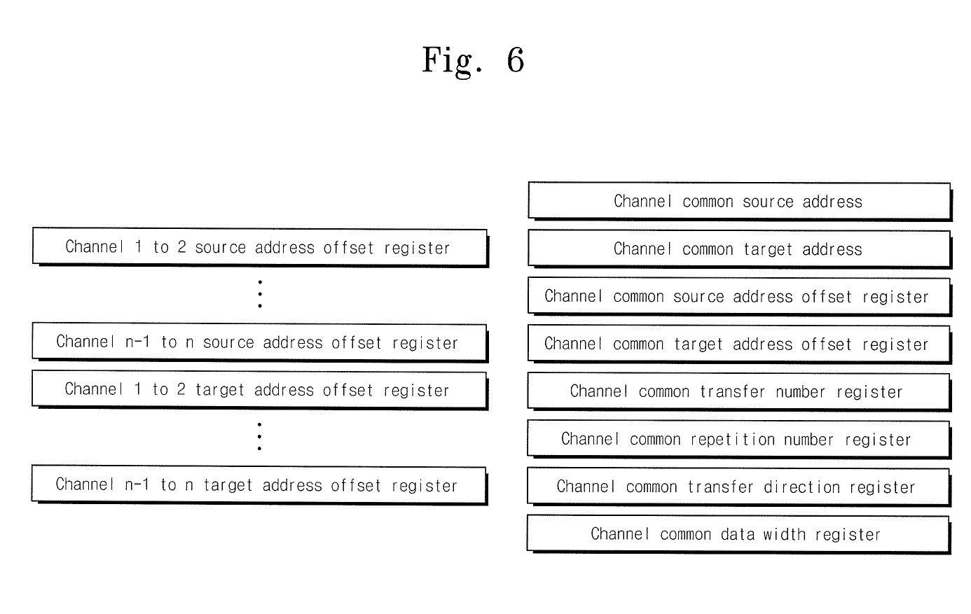

FIG. 6 illustrates the detailed third register of FIG. 3. The third register stores setting data to be used in a plurality of channels.

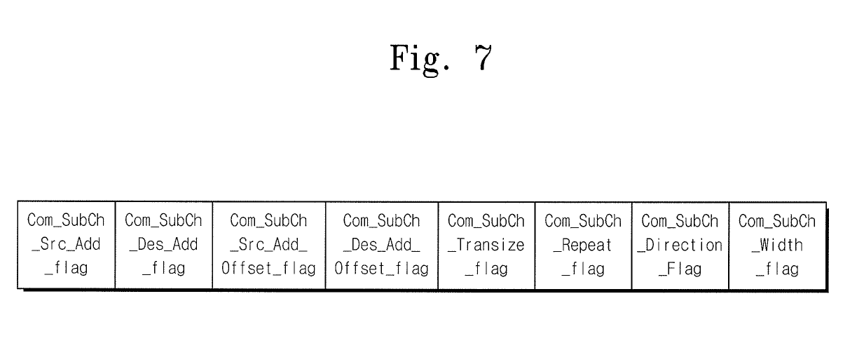

FIG. 7 illustrates the detailed fourth register of FIG. 3. The fourth register controls which data among the setting data are to be used in a plurality of sub channels. For examples, once an item Com_SubCh_Src_Add_flag is activated, a source address indicating a data stored location is transferred to a plurality of sub channels.

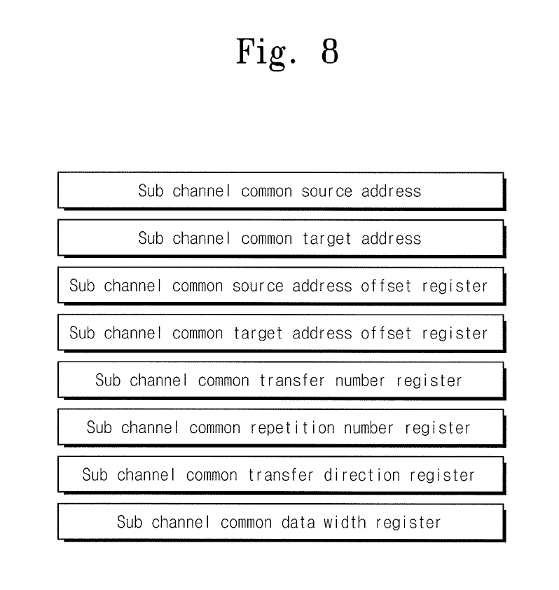

FIG. 8 illustrates the detailed fifth register of FIG. 3. The fifth register stores data to be used in a plurality of sub channels.

As mentioned above, according to the multi media processor and the complex system using a plurality of transfer channels, the DMA controller operates as a multi channel data transfer device. However, control registers equipped with an external processor need to be set in order for multi channel data transfer. This deteriorates system performance.

The multi channel data transfer device according to the embodiment can reduce a control load caused by a processor and improve system bus efficiency by minimizing register setting repetition accompanied during multi channel transfer.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A multi channel data transfer device comprising:
a plurality of channel controllers connected to a plurality of peripheral devices, respectively;
a plurality of control registers storing setting data for controlling an operation of each of the plurality of channel controllers; and
a common register control unit delivering common setting data to all or part of the plurality of control registers, the common setting data being applied in common to all or part of the plurality of channel controllers.

2. The multi channel data transfer device of claim 1, wherein the common register control unit comprises:
a common register receiving setting data from the external;
a common register controller generating the common setting data from the setting data stored in the common register; and
a selection circuit delivering the common setting data to all or part of the plurality of control registers according to a control of the common register controller.

3. The multi channel data transfer device of claim 2, wherein the common register controller comprises:
a common condition analyzer analyzing information with reference to the setting data and generating a control signal, the information being about a channel and a sub channel to which the common setting data are applied;
a channel selector selecting a channel in response to the control signal and the setting data; and
an address operator generating an address in response to the control signal and the setting data.

4. The multi channel data transfer device of claim 2, wherein the common register comprises a register storing information about a channel and a sub channel where the common setting data are to be used.

5. The multi channel data transfer device of claim 2, wherein the common register comprises a register controlling which data among the setting data are to be used in a plurality of channels.

6. The multi channel data transfer device of claim 2, wherein the common register comprises a register storing the setting data to be used in a plurality of channels.

7. The multi channel data transfer device of claim 2, wherein the common register comprises a register controlling which data among the setting data are to be used in a plurality of sub channels.

8. The multi channel data transfer device of claim 2, wherein the common register comprises a register storing data to be used in a plurality of sub channels.

9. The multi channel data transfer device of claim 2, wherein the common register comprises:
a first register storing information about a channel and a sub channel where the common setting data are to be used;
a second register controlling which data among the setting data are to be used in a plurality of channels;
a third register storing the setting data to be used in the plurality of channels;
a fourth register controlling which data among the setting data are to be used in a plurality of sub channels; and
a fifth register storing data to be used in the plurality of sub channels.

10. The multi channel data transfer device of claim 9, wherein the common register controller comprises a common condition analyzer analyzing information with reference to the first, second, and fourth registers and generating a control signal, the information being about a channel and a sub channel to which the common setting data are to be applied.

11. The multi channel data transfer device of claim 10, wherein the common register controller further comprises a channel selector selecting a channel in response to the third and fifth registers and the control signal.
